(19) United States
(12) Patent Application Publication
(10) Pub. No.: US 2011/0125387 A1
(43) Pub. Date: May 26, 2011

(54) FUEL SUPPLY SYSTEM HAVING PRESSURE CONTROL VALVE

(75) Inventors: Takashi SUZUKI, Chiryu-city (JP); Masayuki Kobayashi, Kasugai-city (JP); Yoshihiko Itoh, Nisshin-city (JP); Shinobu Oikawa, Kariya-city (JP); Hiroshi Inoue, Anjo-city (JP)

(73) Assignee: DENSO CORPORATION, Kariya-city (JP)

(21) Appl. No.: 12/907,228

(22) Filed: Oct. 19, 2010

(30) Foreign Application Priority Data
Nov. 26, 2009 (JP) 2009-268971
May 21, 2010 (JP) 2010-117173

(51) Int. Cl. F02M 37/04; F02M 55/02

(52) U.S. Cl. 701/103; 123/294

(57) ABSTRACT

A pressure control valve is provided in a fuel return pipe connected between a high pressure fuel pipe and a fuel pressurizing chamber of a high pressure pump. A pressure relief valve is opened when fuel pressure in a fuel delivery pipe is higher than a first pressure. A first valve body of the pressure relief valve is brought into contact with a stopper so that a movement of the first valve body is limited. A pressure holding valve, which is provided in an inside of the first valve body, is opened when the fuel pressure in the fuel delivery pipe is larger than a second pressure. When the pressure relief valve is opened and the first valve body crashes into the stopper, a lifting amount of a second valve body of the pressure holding valve is increased by inertia of the second valve body, so that extraneous material attached to the second valve body can be removed.

### CROSS REFERENCE TO RELATED APPLICATION

This application is based on Japanese Patent Applications No. 2009-268971 filed on Nov. 26, 2009, and No. 2010-117173 filed on May 21, 2010, the disclosures of which are incorporated herein by reference.

### FIELD OF THE INVENTION

The present invention relates to a fuel supply system for an internal combustion engine, in particular, relates to a pressure control valve provided in the fuel supply system.

### BACKGROUND OF THE INVENTION

In a conventional fuel supply system for a direct injection type gasoline engine, a fuel from a fuel tank is pressurized by a high pressure pump and pressurized high fuel is supplied to and stored in a fuel delivery pipe, so that the high pressure fuel is injected into combustion chambers of the engine through fuel injection devices connected to the fuel delivery pipe.

In the fuel supply system of this kind, a pressure relief valve is provided so as to decrease the fuel pressure in the fuel delivery pipe, when the fuel pressure in the fuel delivery pipe is increased to such a value higher than a predetermined pressure, at which fuel injection through the fuel injection devices may become unable.

Furthermore, a constant residual pressure valve (also referred to as a pressure holding valve) is provided in the fuel supply system in order to decrease the fuel pressure in the fuel delivery pipe when an acceleration pedal is released from pressing or engine operation is stopped, and to maintain the fuel pressure in the fuel delivery pipe at a predetermined constant value.

A pressure control valve is composed of the above pressure relief valve and the constant residual pressure valve (the pressure holding valve).

The constant residual pressure valve (the pressure holding valve) is provided in the fuel supply system so as to suppress occurrence of the following problems (1) and (2):

(1) A problem, which may occur in the case that the fuel pressure is maintained at the constant high value in the fuel delivery pipe when releasing the acceleration pedal:

When the acceleration pedal is released from pressing during engine operation, fuel injection from the fuel injection devices is stopped. If the fuel pressure in the fuel delivery pipe was maintained at the high pressure during such a case (pressure release of the acceleration pedal), it may become difficult to smoothly control amount of fuel injection from the fuel injection devices into the combustion chambers when the acceleration pedal is pressed again. And thereby, the fuel injection amount injected from the fuel injection devices into the respective combustion chambers may become larger than a target value. As a result, fuel consumption ratio may be decreased, a shock may be generated during a vehicle accelerating operation, and so on.

(2) A problem, which may be caused by fuel pressure increase in the fuel delivery pipe after stopping the engine operation:

When the engine operation is stopped, circulation of engine cooling water is also stopped. As a result, temperature in an engine room of a vehicle is increased for a predetermined period after the stop of the engine operation, and then the temperature will be gradually decreased. Accordingly, the fuel pressure in the fuel delivery pipe is correspondingly increased for such predetermined period after the stop of the engine operation and decreased thereafter. When the fuel pressure is increased in the fuel delivery pipe, the fuel may leak from the fuel injection devices into the combustion chambers. The fuel leaked into the combustion chambers may be emitted into the air as unburned components at starting the engine next time, which may deteriorate emission.

According to a constant residual pressure valve (a pressure holding valve) of a prior art, for example, as disclosed in Japanese Patent Publication No. 2009-121395, the pressure holding valve is provided in a high pressure fuel line connecting a fuel pressurizing chamber of a high pressure pump with a fuel delivery pipe. The pressure holding valve is opened when the fuel pressure in the fuel delivery pipe becomes higher than the fuel pressure in the fuel pressurizing chamber by a predetermined pressure. The pressure holding valve not only decreases the fuel pressure in the fuel delivery pipe, when releasing the acceleration pedal or stopping the engine operation, but also maintains the fuel pressure in the fuel delivery pipe at a predetermined lower value. The pressure holding valve of the above prior art suppresses the above mentioned problems (1) and (2).

According to the pressure holding valve of the above prior art, an orifice for restricting fuel flow is provided on a side of a valve body for opening or closing the fuel line, which is a side closer to the fuel delivery pipe. Therefore, a lifting amount of the valve body when opening the fuel line is small. In addition, a direction of the fuel flowing at the valve body is one way. Accordingly, when the engine is operated for a long period, extraneous material contained in the fuel may be attached to a portion between the valve body and its valve seat and such extraneous material may be accumulated. When it occurs, fluid tightness (sealing performance) between the valve body and valve seat maybe deteriorated, and thereby function of the pressure holding valve for keeping the fuel pressure at the constant value may be deteriorated.

When the function of the pressure holding valve for keeping the fuel pressure at the constant value is deteriorated, the following problems (3) and (4) may occur:

(3) A problem, which may be caused by fuel pressure decrease in the fuel delivery pipe when accelerating the vehicle again after having released the acceleration pedal:

In the case that the fuel pressure is excessively decreased after the acceleration pedal is released, emission may be deteriorated when accelerating the vehicle again. This is because the fuel injection may be started before the fuel pressure in the fuel delivery pipe is restored (increased) to its fuel injection pressure. In such a case, atomization of fuel injected from the fuel injection devices may not be sufficiently achieved.

(4) A problem, which may be caused by the fuel pressure decrease in the fuel delivery pipe when starting the engine again at high temperature:

When the engine is re-started within a period of some ten minutes from stopping the engine operation, the temperature of the engine is still high. When the fuel pressure in the fuel delivery pipe is decreased to saturated vapor pressure, vapor may be generated in the fuel. As a result, pressurization of the fuel may not be sufficiently achieved, which may cause deterioration of fuel consumption and starting performance.

### SUMMARY OF THE INVENTION

The present invention is made in view of the above problems. It is an object of the present invention to provide a pressure control valve, in which extraneous material may be hardly attached to the pressure control valve to thereby maintain function of a pressure holding valve at a satisfactory condition.

According to a feature of the invention (for example, as defined in the appended claim 1), a fuel supply system for an internal combustion engine comprises; a high pressure pump having a fuel pressurizing chamber for pressurizing low pressure fuel from a fuel tank; a fuel delivery pipe for storing high pressure fuel pressurized by the high pressure pump; a fuel injection device for injecting the high pressure fuel stored in the fuel delivery pipe into a cylinder of the engine; and a pressure control valve for controlling fuel pressure in the fuel delivery pipe.

The pressure control valve has a pressure relief valve and a pressure holding valve.

The pressure relief valve is provided in a fuel return pipe which is connected between a high-pressure side of a fuel line for the high pressure pump and a low-pressure side of the fuel line for the high pressure pump. The pressure relief valve has a first valve body movably accommodated in the fuel return pipe. The first valve body is operatively separated from a first valve seat formed at an inner peripheral wall of the fuel return pipe, when fuel pressure at the high-pressure side of the fuel line becomes higher than a first pressure, in order to open the pressure relief valve so that fuel flows from the high-pressure side of the fuel line to the low-pressure side of the fuel line.

When the first valve body is separated from the first valve seat, the first valve body is brought into contact with a stopper provided in the fuel return pipe, so that a movement of the first valve body is limited.

The pressure holding valve is provided in an inside fuel passage formed in the first valve body and having a second valve body movably accommodated in the inside fuel passage. The second valve body is operatively separated from a second valve seat formed at an inner peripheral wall of the inside fuel passage, when the fuel pressure at the high-pressure side of the fuel line becomes higher than a second pressure which is lower than the first pressure, in order to open the pressure holding valve so that fuel flows from the high-pressure side of the fuel line to the low-pressure side of the fuel line.

A direction of the valve movement for opening the pressure relief valve is the same to that for the pressure holding valve. And as explained above, the pressure holding valve is provided in the inside fuel passage formed in the first valve body. When the pressure relief valve is opened, the pressure holding valve is moved together with the first valve body in the direction toward the stopper. When the first valve body crashes into the stopper, the second valve body is further moved in the direction to the stopper by the inertia of second valve body depending on the mass thereof. As a result, a lifting amount of the second valve body can be made larger than that in a normal operation of the pressure holding valve. And the extraneous material attached to (and accumulated at) the second valve body can be removed by the fuel flow through the space between the second valve body and the second valve seat. In addition, the extraneous material attached to the second valve body can be broken into pieces by vibration generated at the crash between the first valve body and the stopper. The pressure holding valve can increase its anti-extraneous performance to thereby maintain the pressure holding performance. Thus, it is possible to suppress deterioration of the performance of the pressure holding valve.

In the above features of the invention, it is possible to set the first pressure at any desirable value. For example, the first pressure is set at such a value, at which normal operation for the fuel injection of the fuel injection device can be maintained. In other words, the first pressure is set at the value, which is higher than fuel pressure in high pressure side of the fuel line for the normal engine operation but lower than fuel pressure at which the fuel injection by the fuel injection device may become unable.

The pressure, at which the fuel injection by the fuel injection device may become unable, is such a high fuel pressure, according to which a valve pressing force (a valve closing force) is higher than a valve lifting force (a valve opening force). The valve pressing force is a force applied by the high fuel pressure to a valve member for opening/closing injection ports of the fuel injecting device and to a moving member in a valve closing direction, wherein a force applied to a cross sectional area of the injection port is subtracted. The valve lifting force is a force applied to the valve member and the moving member by the high fuel pressure and electromagnetic force in a valve opening direction.

It is also possible to set the second pressure at any desirable value. For example, the second pressure is set at such a value, which is higher than saturated vapor pressure but lower than a fuel pressure in the high-pressure side of the fuel line during an idling operation of the engine.

According to another feature of the invention (for example, as defined in the appended claim 2), the fuel supply system has a fuel pressure sensor and an electronic control unit. The fuel pressure sensor detects fuel pressure at the high-pressure side of the fuel line or the fuel pressure in the fuel delivery pipe. The electronic control unit directly or indirectly operates the pressure relief valve so as to open the pressure relief valve when the fuel pressure detected by the fuel pressure sensor is lower than the second pressure, so that the first valve body crashes into the stopper.

When the fuel pressure detected by the fuel pressure sensor is lower than the second pressure, there is a possibility that extraneous material may be attached to or accumulated at a space between the second valve body and the second valve seat. Therefore, the electronic control unit operates the pressure relief valve so as to open the pressure relief valve and thereby the first valve body crashes into the stopper. As a result, the extraneous material attached to (and accumulated at) the second valve body can be removed.

According to a further feature of the invention (for example, as defined in the appended claim 3), the electronic control unit detects (determines) whether the fuel pressure detected by the fuel pressure sensor is lower than the second pressure, after engine operation is stopped.

The electronic control unit and its related components are kept in operation for a predetermined period even after the engine operation is stopped, in order to accurately detect any characteristic change and/or performance deterioration of the pressure holding valve.

According to a still further feature of the invention (for example, as defined in the appended claim 4), the electronic control unit operates the pressure relief valve when the engine is started, so that the first valve body is moved in a valve opening direction and thereby the first valve body crashes into the stopper.

Shortly after the engine operation is started, the engine is rotated at a higher speed. Since the operating sound of the pressure relief valve is mixed with the operating sound of the engine, it is possible to suppress deterioration for calmness and drivability of the vehicle.

According to a still further feature of the invention (for example, as defined in the appended claim 5), the electronic control unit operates the pressure relief valve during the engine operation, when the fuel Pressure detected by the fuel pressure sensor reaches at a predetermined value which is close to the first pressure, so that the first valve body is moved in a valve opening direction and thereby the first valve body crashes into the stopper.

When the fuel pressure detected by the fuel pressure sensor reaches at a predetermined value which is close to the first pressure, in most of cases, the engine is rotated at high speed. Therefore, as a result that the operating sound of the pressure relief valve and the operating sound of the engine are mixed with each other, the deterioration for calmness and drivability of the vehicle can be suppressed.

According to a still further feature of the invention (for example, as defined in the appended claim 6), the electronic control unit controls discharge amount of the fuel from the high pressure pump to thereby increase the fuel pressure in the fuel delivery pipe above the first pressure, so that the first valve body is moved in a valve opening direction.

Since the first valve body of the pressure relief valve is driven to move by controlling the discharge amount of the fuel from the high pressure pump, it is possible to remove the extraneous material attached to or accumulated at the second valve body by a simple structure.

According to a still further feature of the invention (for example, as defined in the appended claim 7), the electronic control unit stops fuel injection from the fuel injection device into the cylinder and at the same time controls the high pressure pump to continuously discharge the high pressure fuel, to thereby increase the fuel pressure in the fuel delivery pipe above the first pressure.

Since the fuel pressure in the fuel delivery pipe is increased by stopping the fuel injection from the fuel injection device into the cylinder, it is possible to rapidly increase the fuel pressure in the fuel delivery pipe above the first pressure.

When the pressure relief valve is opened, the fuel pressure in the fuel delivery pipe is decreased. As a result, atomization of the fuel injected from the fuel injection device may be deteriorated and/or fuel injection amount may be decreased. Therefore, the emission of the exhaust gas and drivability may be deteriorated. However, according to the above feature, the operation for the pressure relief valve is stopped at a timing, at which occurrence of the deterioration for the emission and/or drivability may be avoided.

According to a still further feature of the invention (for example, as defined in the appended claim 8), an electromagnetic coil is provided around the pressure relief valve for generating magnetic field upon receiving electrical power, and the first valve body of the pressure relief valve is moved in a direction toward the stopper by the magnetic field generated at the electromagnetic coil.

As a result, it is possible to operate the pressure relief valve, that is, to move the first valve body, at any desirable timing, without stopping the operation for controlling the discharge amount from the high pressure pump and/or fuel injection from the fuel injection device. It is, therefore, possible to wipe out the fear for the deterioration of the emission and/or the drivability.

According to a still further feature of the invention (for example, as defined in the appended claim 9), an electromagnetic coil is provided around the pressure relief valve for generating magnetic field upon receiving electrical power, and a flux drawing portion is provided in the pressure holding valve. And the second valve body of the pressure holding valve is moved in a direction away from the second valve seat by the magnetic field generated at the electromagnetic coil.

According to such a feature, it is possible to directly open the second valve body, without opening the first valve body. It is possible not only to open the second valve body at any desirable timing, but also to wipe out the fear for the deterioration of the emission and/or the drivability.

According to a still further feature of the invention (for example, as defined in the appended claim 10), an orifice is provided in the fuel line connected between the high pressure pump and the fuel delivery pipe and at such a position between the fuel return pipe and the fuel delivery pipe, so that the orifice decreases pulsation of the fuel pressure in the fuel delivery pipe and also reflects pressure waves generated by fuel discharge from the high pressure pump. In the above structure, the fuel pressure in the fuel line is higher than the first pressure and the pressure waves generated by fuel discharge from the high pressure pump vibrates sympathetically with the pressure waves reflected by the orifice, when the pressure waves generated by the fuel discharge from the high pressure pump reaches at a predetermined frequency.

According to the above structure, it is possible to open the pressure relief valve, without carrying out a specific operation for opening the pressure relief valve.

According to a still further feature of the invention (for example, as defined in the appended claim 11), the fuel return pipe comprises; a first fuel return pipe, one end of which is connected to the high-pressure side of the fuel lien and the other end of which is connected to the fuel pressurizing chamber of the high pressure pump; and a second fuel return pipe, one end of which is connected to the fuel delivery pipe and the other end of which is connected to the fuel tank. In addition, the pressure control valve comprises a first pressure control valve provided in the first fuel return pipe and a second pressure control valve provided in the second fuel return pipe.

According to the above structure, even if one of the first and second pressure control valves ware broken, the other pressure control valve can control the fuel pressure in the fuel delivery pipe.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a structure of a fuel supply system, to which a pressure control valve according to a first embodiment of the present invention is applied;

FIG. 2 is a schematic cross sectional view showing the pressure control valve according to the first embodiment;

FIG. 3 is a schematic cross sectional view taken along a line III-III in FIG. 2;

FIG. 4 is a graph showing a normal operation of a pressure holding valve of the pressure control valve;

FIGS. 5A and 5B are schematic cross sectional views respectively showing operating conditions of the pressure holding valve;

FIG. 6 is a graph showing an abnormal operation of the pressure holding valve of the pressure control valve;

FIGS. 7A and 7b are flow charts respectively showing processes for the fuel supply system to which the pressure control valve of the present invention is applied;

FIG. 8 is a graph showing operations of respective parts of the fuel supply system of the present invention;

FIGS. 9A to 9C are schematic cross sectional views respectively showing operating conditions of the pressure holding valve in a cleaning mode operation;

FIGS. 10A and 10b are flow charts respectively showing processes for the fuel supply system according to a second embodiment of the present invention;

FIG. 11 is a schematic cross sectional view showing the pressure control valve according to a third embodiment of the present invention;

FIG. 12 is a flow chart showing processes for the fuel supply system according to a fourth embodiment of the present invention;

FIG. 13 is a flow chart showing processes for the fuel supply system according to a fifth embodiment of the present invention;

FIG. 14 is a schematic view showing a structure of the fuel supply system, to which a pressure control valve according to a sixth embodiment of the present invention is applied;

FIG. 15 is a schematic view showing a structure of the fuel supply system, to which a pressure control valve according to a seventh embodiment of the present invention is applied;

FIG. 16 is a schematic cross sectional view showing the pressure control valve according to the seventh embodiment of the present invention;

FIG. 17 is a schematic cross sectional view showing the pressure control valve according to an eighth embodiment of the present invention;

FIG. 18 is a schematic view showing a structure of the fuel supply system, to which a pressure control valve according to a ninth embodiment of the present invention is applied; and

FIG. 19 is a schematic view showing a structure of the fuel supply system, to which a pressure control valve according to a tenth embodiment of the present invention is applied.

### DETAILED DESCRIPTION OF THE PREFERRED EMBODIMENTS

Embodiments of the present invention will be hereinafter explained with reference to the drawings. The same reference numerals are used through multiple embodiments for such components or portions, which are identical or similar to each other, so that overlapped explanation may be omitted.

### First Embodiment

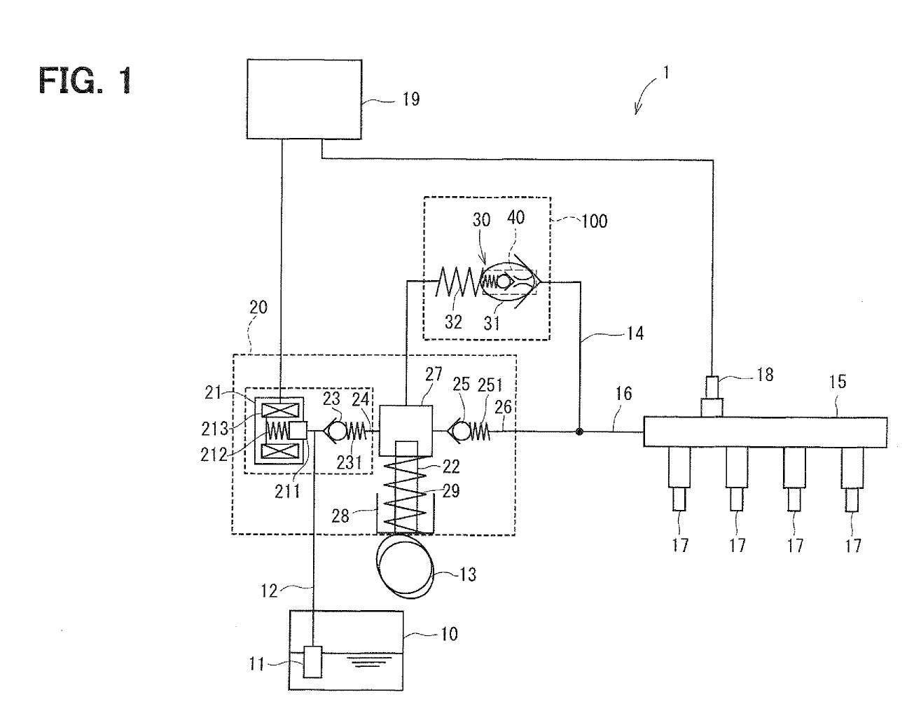

A fuel supply system, to which a pressure control valve according to a first embodiment of the present invention is applied, is a fuel supply system 1 for an internal combustion engine of a direct-injection type, in which fuel is directly injected into cylinders (combustion chambers) the engine. As shown in FIG. 1, the fuel supply system 1 is composed of a fuel tank 10, a high pressure pump 20, a fuel delivery pipe 15, fuel injection devices (injectors) 17, a pressure relief valve 30, a pressure holding valve 40 (also referred to as a constant residual pressure valve), a fuel pressure sensor 18, a controller (an electronic control unit) 19, and so on. A pressure control valve 100 is composed of the pressure relief valve 30, the pressure holding valve 40 and so on.

Fuel is drawn up by a low pressure fuel pump 11 from the fuel tank 10 and supplied to the high pressure fuel pump 20 via a low pressure fuel pipe 12. The fuel is pressurized by the high pressure fuel pump 20 and supplied to the fuel delivery pipe 15 via a high pressure fuel pipe 16. The fuel delivery pipe 15 stores the high pressure fuel. The high pressure fuel stored in the fuel delivery pipe 15 is injected into the cylinders (not shown) of the internal combustion engine via the injectors 17 connected to the fuel delivery pipe 15.

The fuel pressure sensor 18 detects fuel pressure in the fuel delivery pipe 15 and sends its detected information to the controller 19. The controller 19 is composed of an engine control unit (ECU), driving circuits, and so on. The controller 19 controls power supply to an electromagnetic actuator 21 of the high pressure fuel pump 20 (explained below) and other components and devices for the engine, based on signals from an acceleration pedal sensor (not shown), a rotational angle sensor of a cam shaft (not shown) and so on.

A structure of the high pressure fuel pump 20 will be explained. The high pressure fuel pump 20 is composed of a plunger 22, a fuel flow control valve 23, the electromagnetic actuator 21, a discharge valve 25 and so on.

The plunger 22 is formed in a cylindrical shape and movably accommodated in a pump housing (not shown) so as to reciprocate in an axial direction thereof. A fuel pressurizing chamber 27 is formed at a top end side of the plunger 22. The fuel pressurizing chamber 27 varies its working chamber volume in accordance with a reciprocal movement of the plunger 22.

A lifter 28 is provided at a lower end side of the plunger 22 opposite to the fuel pressurizing chamber 27. The lifter 28 is biased by a coil spring 29 in a downward direction, so that the lifter 28 is in contact with a cam shaft 13. Accordingly, the plunger 22 is reciprocated in the axial direction in accordance with the rotation of the cam shaft 13.

The fuel flow control valve 23 is provided in a fuel supply passage 24 connecting a fuel inlet of the high pressure pump 20 and the fuel pressurizing chamber 27. The fuel flow control valve 23 controls to open and/or close the fuel supply passage 24 depending on an operation of the electromagnetic actuator 21.

A load to a spring 212, which biases a moving core 211 of the electromagnetic actuator 21 toward the fuel pressurizing chamber 27, is set at a value larger than a load to a spring 231, which biases the fuel flow control valve 23 in a direction opposite to the fuel pressurizing chamber 27. Therefore, when no electrical power is supplied to the electromagnetic actuator 21, the moving core 211 is moved by the spring force of the spring 212 in the direction to the fuel pressurizing chamber 27. A valve body of the fuel flow control valve 23 is thereby moved in the direction to the fuel pressurizing chamber 27 by a needle (not shown) provided between the moving core 211 and the fuel flow control valve 23. As a result, the valve body of the fuel flow control valve 23 is separated from a valve seat to open the fuel supply passage 24.

When the electrical power is supplied to the electromagnetic actuator 21, the moving core 211 is moved by electromagnetic force generated at a coil 213 in the direction away from the fuel pressurizing chamber 27. Then, the valve body of the fuel flow control valve 23 is likewise moved in the direction away from the fuel pressurizing chamber 27 by the spring force of the spring 231 and fuel pressure in the fuel pressurizing chamber 27, so that the valve body of the fuel flow control valve 23 is seated on the valve seat to close the fuel supply passage 24.

The discharge valve 25 is provided in a fuel discharge passage 26 connecting the fuel pressurizing chamber 27 with a fuel outlet of the high pressure pump 20. A valve body of the discharge valve 25 is moved to open the fuel discharge passage 26, when the fuel pressure from the fuel pressurizing chamber 27 becomes larger than a sum of spring force of a spring 251 and the fuel pressure from the fuel delivery pipe 15.

The discharge valve 25 closes the fuel discharge passage 26, when the fuel pressure from the fuel pressurizing chamber 27 is smaller than the sum of the spring force of the spring 251 and the fuel pressure from the fuel delivery pipe 15.

An operation of the high pressure fuel pump 20 will be explained.

The operation of the high pressure fuel pump 20 is divided into a suction stroke, a returning stroke and a compression stroke.

In the suction stroke, the plunger 22 is moved from its top dead center to a bottom dead center. During this stroke, the power supply to the electromagnetic actuator 21 is stopped, so that fuel flow control valve 23 opens the fuel supply passage 24, as explained above. Since the pressure in the fuel pressurizing chamber 27 is decreased in accordance with a downward movement of the plunger 22, the fuel is sucked into the fuel pressurizing chamber 27 from the fuel supply passage 24.

In the returning stroke, the plunger 22 is moved from the bottom dead center toward the top dead center. During this stroke, the power supply to the electromagnetic actuator 21 is still cut off so that the fuel flow control valve 23 continuously opens the fuel supply passage 24. Therefore, the fuel is discharged from the fuel pressurizing chamber 27 back into the fuel supply passage 24.

In the compression stroke, the electric power is supplied to the electromagnetic actuator 21 when the plunger 22 is on away from the bottom dead center to the top dead center, in order to close the fuel supply passage 24 by the fuel flow control valve 23. When the plunger 22 is further moved toward the top dead center, while the fuel supply passage 24 is closed, the fuel pressure in the fuel pressurizing chamber 27 is increased. When the fuel pressure in the fuel pressurizing chamber 27 becomes higher than a predetermined pressure, the discharge valve 25 opens the fuel discharge passage 26. As a result, the high pressure fuel is discharged from the fuel discharge passage 26 into the high pressure fuel pipe 16.

A fuel return pipe 14 is provided between the fuel pressurizing chamber 27 of the high pressure fuel pump 20 and the high pressure fuel pipe 16. One end of the fuel return pipe 14 may be connected to a fuel line of a higher pressure side of the high pressure fuel pump 20, while the other end of the fuel return pipe 14 may be connected to the fuel line of a lower pressure side of the high pressure fuel pump 20. The fuel line of the higher pressure side of the high pressure fuel pump 20 may include; the fuel discharge passage 26 between the discharge valve 25 and the fuel outlet of the high pressure fuel pump 20; the high pressure fuel pipe 16; the fuel delivery pipe 15; and so on. On the other hand, the fuel line of the lower pressure side of the high pressure fuel pump 20 may include; the fuel discharge passage 26 between the discharge valve 25 and the fuel pressurizing chamber 27; the fuel pressurizing chamber 27; the fuel supply passage 24; the low pressure fuel pipe 12; the fuel tank 11; and so on.

The pressure relief valve 30 is provided in the fuel return pipe 14. The pressure holding valve 40 is provided at an inside of a first valve body 31 forming the pressure relief valve 30.

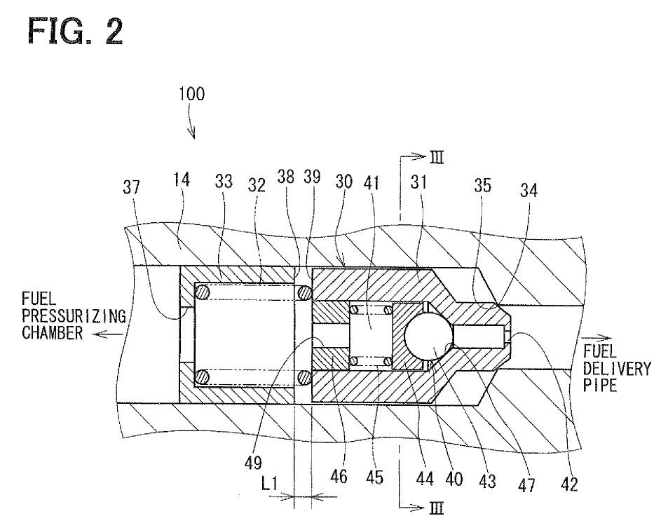

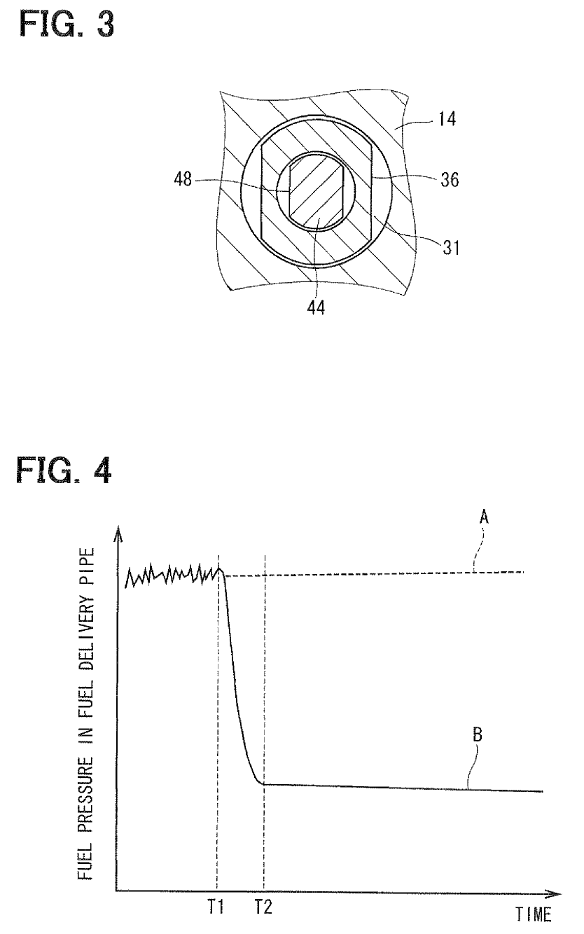

The pressure control valve 100, which is composed of the pressure relief valve 30 and the pressure holding valve 40, will be explained with reference to FIGS. 2 and 3.

The pressure relief valve 30 has the first valve body 31, a first spring 32, a stopper 33 and so on.

The first valve body 31 is formed in a cylindrical shape and movably accommodated in the fuel return pipe 14, so that the first valve body 31 moves in an axial direction thereof. The first valve body 31 has a conical valve surface portion 34 at an axial end on a side to the fuel delivery pipe 15. The conical valve surface portion 34 is able to be seated on a first valve seat 35 formed at an inner peripheral wall of the fuel return pipe 14.

A chamfered portion 36 (FIG. 3) is formed at an outer peripheral wall of the first valve body 31, so that fuel may flow through a space between the inner peripheral wall of the fuel return pipe 14 and the chamfered portion(s) 36.

The stopper 33 is formed in a cylindrical shape having a bottom portion and fixed to the inner peripheral wall of the fuel return pipe 14. The stopper 33 is arranged at a side of the first valve body 31 to the fuel pressurizing chamber 27. A through-hole 37 is formed at the bottom portion of the stopper 33, so that the fuel may flow through the through-hole 37.

The first spring 32 is a compressed coil spring. One end of the first spring 32 is locked to an end surface portion 39 of the first valve body 31, which is formed at an end of the first valve body 31 opposite to the valve surface portion 34. The other end of the first spring 32 is locked to an inner wall of the stopper 33 (the bottom portion) at a portion adjacent to the through-hole 37. The first spring 32 biases the first valve body 31 toward the first valve seat 35.

A movable space L1 is formed between the end surface portion 39 of the first valve body 31 and an end surface portion 38 of the stopper 33, which is formed at an axial end of the stopper 33 facing to the first valve body 31. The first valve body 31 is movable within the range of the movable space L1. The movable space L1 corresponds to a maximum lift amount of the pressure relief valve 30, when it opens the fuel return pipe 14.

The fuel pressure on the side of the fuel delivery pipe 15 is applied to the first valve body 31, which will be separated from the first valve seat 35 when the fuel pressure on the side of the fuel delivery pipe 15 applied to the first valve body 31 becomes larger than a sum of the fuel pressure on the side of the fuel pressurizing chamber 27 applied to the first valve body 31 and the spring force of the first spring 32. Namely, the first valve body 31 is moved to open the fuel return pipe 14, when the fuel pressure on the side of the fuel delivery pipe 15 becomes higher than a first threshold value (a first pressure). In other words, a load of the first spring 32 is so set that the first valve body 31 is moved to open the fuel return pipe 14, only when the fuel pressure on the side of the fuel delivery pipe becomes higher than the first threshold value. For example, the first threshold value is set at such a value, which is higher than the fuel pressure in the fuel delivery pipe 15 for the normal operation of the internal combustion engine but lower than the fuel pressure at which the injectors 17 may become unable to perform fuel injection.

An inside fuel passage 41 is formed at an inside of the first valve body 31. The pressure holding valve 40 is provided in the inside fuel passage 41. The pressure holding valve 40 is composed of a fuel restricting portion 42, a second valve body 43, a sliding member 44, a second spring 45, a stopping member 46 and so on.

The fuel restricting portion 42 is formed in the inside fuel passage 41 at a side to the fuel delivery pipe 15, that is a forward end of the first valve body 31. A cross sectional area of the fuel restricting portion 42 is set at such a value that the fuel pressure in the fuel delivery pipe 15 may be decreased within a predetermined time period.

The second valve body 43 is formed in a ball shape. The second valve body 43 is seated on a second valve seat 47 of a conical surface, which is formed at an inner peripheral wall of the inside fuel passage 41. The sliding member 44 is provided at a side of the second valve body 43, which is on the side to the fuel pressurizing chamber 27. The second valve body 43 is in a sliding contact with a recessed surface of a hemispherical shape of the sliding member 44. A chamfered portion 48 (FIG. 3) is formed at an outer peripheral portion of the sliding member 44, so that fuel may flow through a space formed between the inner peripheral wall of the inside fuel passage 41 and the chamfered portion(s) 48.

The stopping member 46 is fixed to an end of the first valve body 31 at a side to the fuel pressurizing chamber 27, that is, at a backward of the first valve body 31. A through-hole 49 is formed at the stopping member 46, so that the fuel may flow through the through-hole 49.

The second spring 45 is a compressed coil spring. One end of the second spring 45 is locked to an end surface portion of the sliding member 44, which is at the side to the fuel pressurizing chamber 27. The other end of the second spring 45 is locked to an end wall of the stopping member 46 at a portion adjacent to the through-hole 49. The second spring 45 biases the second valve body 43 toward the second valve seat 47.

The fuel pressure in the fuel delivery pipe 15 is applied to the second valve body 43, and the second valve body 43 will be separated from the second valve seat 47 when the fuel pressure in the fuel delivery pipe 15 applied to the second valve body 43 becomes larger than a sum of the fuel pressure in the fuel pressurizing chamber 27 applied to the second valve body 43 and the spring force of the second spring 45. Namely, the second valve body 43 is moved to open the fuel restricting portion 42, when the fuel pressure in the fuel delivery pipe becomes higher than a second threshold value (a second pressure). In other words, a load of the second spring 45 is so set that the second valve body 43 is moved to open the fuel restricting portion 42, only when the fuel pressure in the fuel delivery pipe 15 becomes higher than the second threshold value. For example, the second threshold value is set at such a value, which is higher than saturated vapor pressure of the fuel but lower than the fuel pressure in the fuel delivery pipe 15 at idling operation of the internal combustion engine.

An operation of the pressure holding valve 40 will be explained.

FIG. 4 shows changes of the fuel pressure in the fuel delivery pipe 15 in a case in which the fuel supply system has the pressure holding valve on one hand, and in a case the fuel supply system does not have such pressure holding valve on the other hand. When the engine operation is stopped at a time point T1, the operation of the high pressure fuel pump 20 is stopped in accordance with the operation stop of the cam shaft. In the case that the fuel supply system does not have the pressure holding valve, the fuel pressure in the delivery pipe 15 is maintained at the high pressure, as indicated by a dotted line A. In this situation, when the fuel pressure in the fuel delivery pipe 15 may be further increased in accordance with the temperature increase of the engine room, which may occur when the circulation of engine cooling water is stopped as a result of the stop of the engine operation, fuel leakage may occur from the injectors into the cylinders of the engine.

On the other hand, in the case that the fuel supply system has the pressure holding valve, the fuel pressure in the delivery pipe 15 is decreased during a period between the time points T1 and T2, and maintained at a lower second pressure (corresponding to the second threshold value), as indicated by a solid line B.

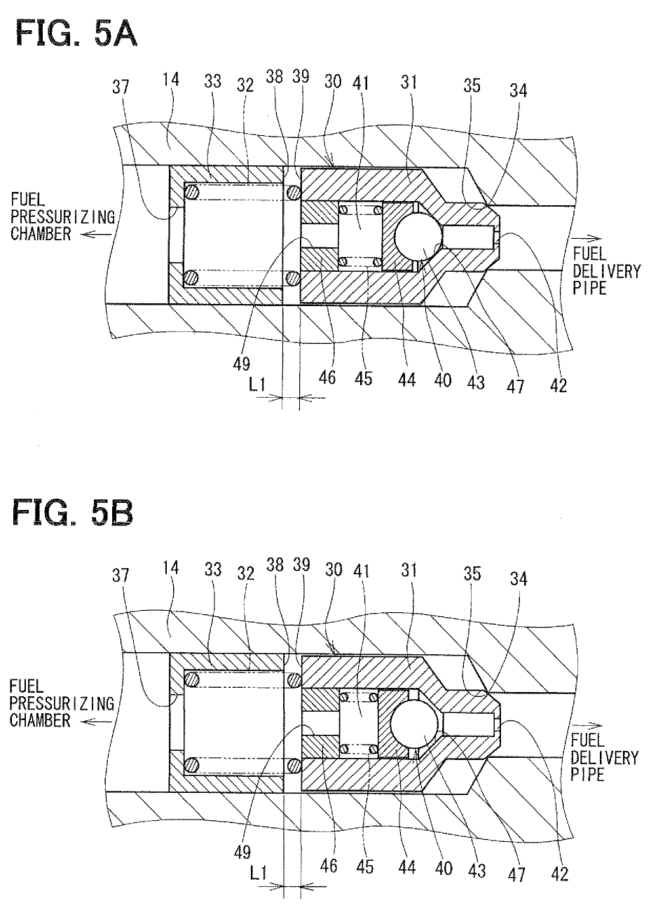

A general operation of the pressure holding valve 40 will be explained with reference to FIGS. 5A and 5B.

The fuel pressure in the fuel delivery pipe 15 is applied to the second valve body 43. However, the second valve body 43 is seated on the second valve seat 47, as shown in FIG. 5A, when the fuel pressure in the fuel delivery pipe 15 applied to the second valve body 43 is smaller than the sum of the fuel pressure in the fuel pressurizing chamber 27 applied to the second valve body 43 and the spring force of the second spring 45.

The second valve body 43 is separated from the second valve seat 47, as shown in FIG. 3B, when the fuel pressure in the fuel delivery pipe 15 applied to the second valve body 43 becomes larger than the sum of the fuel pressure in the fuel pressurizing chamber 27 applied to the second valve body 43 and the spring force of the second spring 45. In this situation, the fuel flows from the fuel delivery pipe 15 to the fuel pressurizing chamber 27 through the fuel restricting portion 42 and the space between the second valve body 43 and the second valve seat 47. As a result, the fuel pressure in the fuel delivery pipe 15 is decreased.

Thereafter, when the fuel pressure in the fuel delivery pipe 15 is decreased to the second pressure (corresponding to the second threshold value), the second valve body 43 is seated again on the second valve seat 47, as shown in FIG. 5A. Therefore, fuel flow in the inside fuel passage 41 is cut off. As a result, the fuel pressure in the fuel delivery pipe 15 is maintained at the second pressure.

Not only after the stop of the engine operation, but also during the normal operation of the high pressure fuel pump 20, the pressure holding valve 40 repeats the ON-OFF operation, namely a closing operation during the compression stroke and an opening operation during the suction stroke.

When the pressure holding valve 40 is operated, the flow amount of the fuel flowing through the fuel restricting portion 42 is controlled. Therefore, the lifting amount of the second valve body 43 is limited to a small value. As a result, extraneous material contained in the fuel may be attached to the space between the second valve body 43 and the second valve seat 47, when the engine is operated for many hours. Since the fuel flow in the inside fuel passage 41 is one way, the extraneous material attached to the space between the second valve body 43 and the second valve seat 47 may not be removed but accumulated. When the extraneous material is attached to and accumulated at the space between the second valve body 43 and the second valve seat 47, the function of the pressure holding valve 40 for maintaining the fuel pressure at the second pressure may be deteriorated.

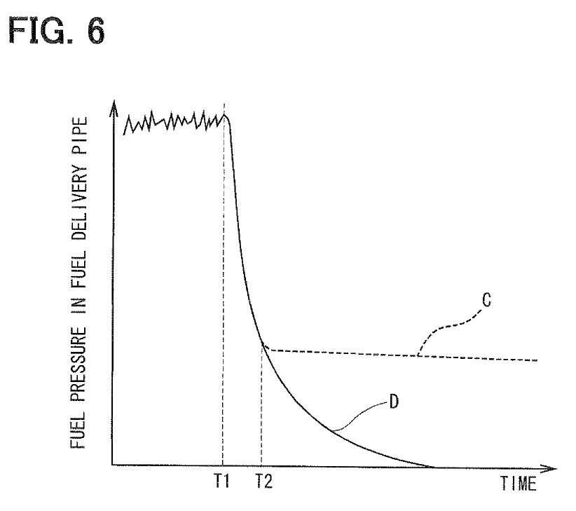

FIG. 6 shows the change of the fuel pressure in the fuel delivery pipe in the cases, where the pressure holding valve 40 is normally operated and where the function of the pressure holding valve 40 is decreased.

In the case that the pressure holding valve 40 is normally operated, the fuel pressure in the fuel delivery pipe 15 is decreased during the period between the time points T1 and T2, after the engine operation is stopped at the time point T1. And the fuel pressure is maintained at the second pressure after the time point T2, as indicated by a dotted line C.

On the other hand, when the extraneous material contained in the fuel is attached to or accumulated at the space between the second valve body 43 and the second valve seat 47, and thereby the function of the pressure holding valve 40 is decreased, the fuel pressure in the fuel delivery pipe 15 is likewise decreased during the period between the time points T1 and T2. However, even after the time point T2, the fuel pressure may be decreased, without being held at the second pressure, as indicated by a solid line D. In this situation, vapor maybe generated in the fuel, the pressure increase at the high pressure fuel pump 20 can not be sufficiently achieved, and the performance of starting the engine may be deteriorated.

According to the present invention, when the function of the pressure holding valve 40 for maintaining the fuel pressure at the desired value is decreased, the controller 19 controls the power supply to the electromagnetic actuator 21 of the high pressure fuel pump 20 in order to start a cleaning mode operation, in which the pressure relief valve 30 is operated.

A control process for the cleaning mode operation will be explained with reference to FIGS. 1, 6, 7A and 7B.

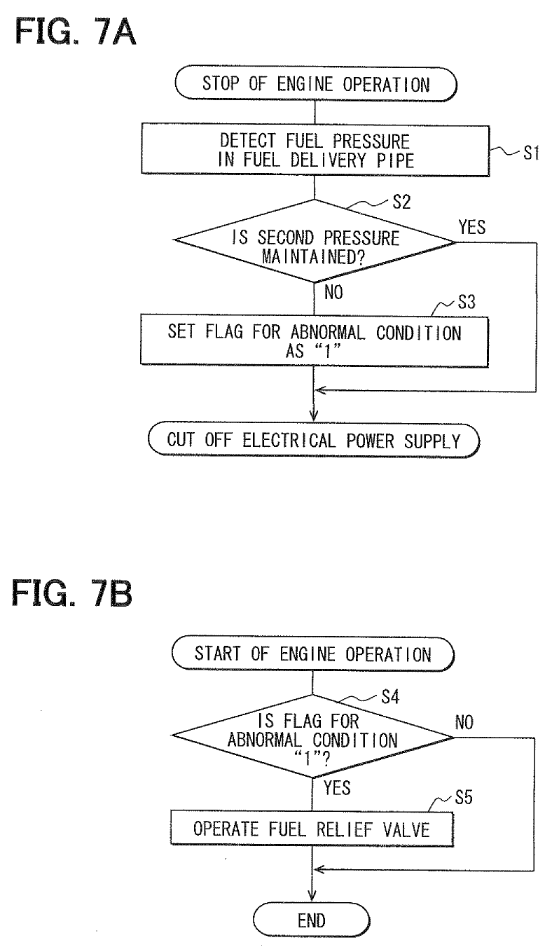

As shown in FIG. 7A, the power supply to the controller 19 is maintained for a predetermined time period, even after the engine operation is stopped. At a step S1, the controller 19 monitors the output of the fuel pressure sensor 18 to detect the fuel pressure in the fuel delivery pipe 15.

At a step S2, when the fuel pressure in the fuel delivery pipe 15 is maintained at the second pressure for a predetermined time, after the time point T2 shown in FIG. 6, that is, YES at the step S2, the power supply to the controller 19 is cut off.

On the other hand, when the fuel pressure in the fuel delivery pipe 15 is decreased to the value lower than the second pressure after the time point T2 shown in FIG. 6, that is, NO at the step S2, the controller 19 sets at a step 53 a flag for the abnormal condition to “1”, stores it in its memory device, and then the power supply to the controller 19 is cut off.

When the engine is re-started, the controller 19 determines, at a step 54 of FIG. 7B, whether the flag for the abnormal condition stored in the memory is “1” or not. When the flag is not “1” (NO at the step S4), the process goes to an end.

On the other hand, when the flag is “1” (YES at the step S4), the controller 19 controls the power supply to the electromagnetic actuator 21 of the high pressure pump 20 (at a step S5), so that the high pressure fuel pump 20 is brought into its pumping operation for discharging the high pressure fuel. As a result, the fuel pressure in the fuel delivery pipe 15 is increased to the pressure higher than the first pressure (the first threshold value). In this situation, fuel discharged amount is controlled at a value larger than the fuel amount to be injected into the cylinders of the engine through the injectors 17 at starting the engine operation. As a result, when the fuel pressure in the fuel delivery pipe 15 is increased to the pressure higher than the first pressure (the first threshold value), the pressure relief valve 30 is moved in the valve opening direction to carry out the cleaning mode operation.

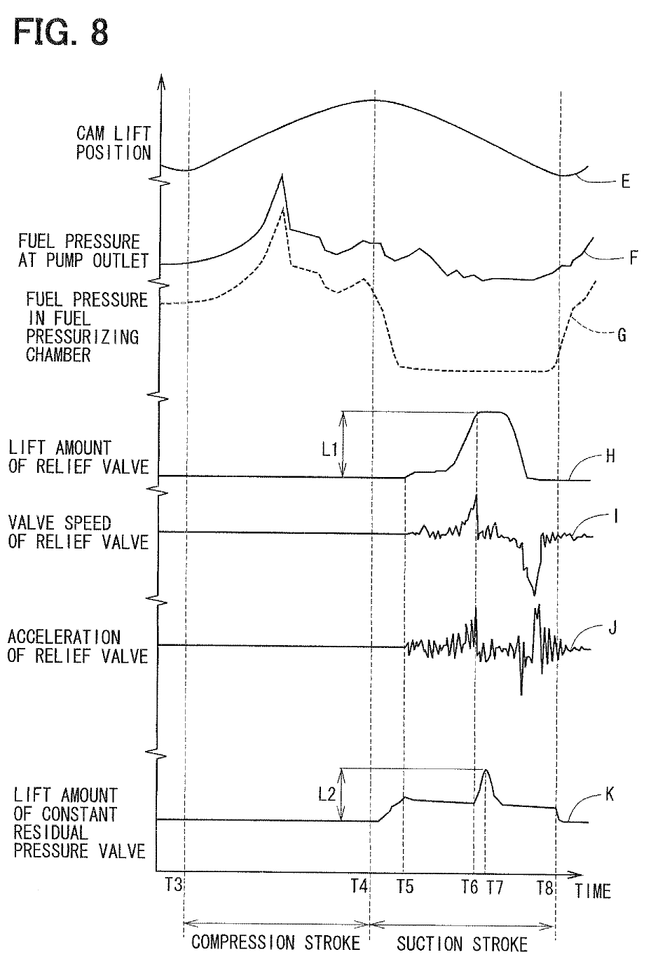

The cleaning mode operation will be explained with reference to FIGS. 1 and 8.

In FIG. 8, as indicated by a solid line E, when a cam lift position (that is, a plunger position) varies from the bottom dead center to the top dead center during a period from T3 to T4, the compression stroke is carried out. When the cam lift position is changed from the top dead center to the bottom dead center during a period from T4 to T8, the suction stroke is carried out. During the compression stroke, the electrical power is supplied to the electromagnetic actuator 21 from the controller so that the high pressure pump 20 pressurizes and pumps out all of the sucked fuel.

As indicted by a solid line F, when the discharge valve 25 is opened on the way from T3 to T4, the fuel pressure at the pump outlet is increased. When the discharge valve 25 is closed, the fuel pressure at the pump outlet is decreased to the fuel pressure equal to the fuel pressure in the fuel delivery pipe 15.

As indicated by a dotted line G, the fuel pressure in the fuel pressurizing chamber 27 is increased in accordance with the cam lift position, namely as the plunger 22 is upwardly moved during the period from T3 to T4, and the fuel pressure in the fuel pressurizing chamber 27 is decreased when the discharge valve 25 is opened. In addition, the fuel pressure in the fuel pressurizing chamber 27 is decreased during the period from T4 to T8, during which the plunger 22 is moved from the top dead center to the bottom dead center in accordance with the cam lift position.

As above, during the period from T3 to T4, the fuel pressure at the pump outlet and the fuel pressure in the fuel pressurizing chamber 27 are changed in a similar pattern to each other. On the other hand, during the period from T4 to T8, the fuel pressure at the pump outlet becomes much higher than the fuel pressure in the fuel pressurizing chamber 27.

As already explained, one end of the fuel return pipe 14, in which the pressure relief valve 30 is provided, is connected to the high pressure fuel pipe 16, while the other end of the fuel return pipe 14 is connected to the fuel pressurizing chamber 27. One end of the high pressure fuel pipe 16 is connected to the fuel discharge passage 26 of the high pressure pump 20, while the other end of the high pressure fuel pipe 16 is connected to the fuel delivery pipe 15. As a result, the fuel pressure in the fuel return passage 14 on the side to the fuel delivery pipe 15 is almost equal to the fuel pressure at the pump outlet and the fuel pressure in the fuel delivery pipe 15.

During the period from T3 to T4, the fuel pressure in the fuel return pipe 14 on the side to the fuel delivery pipe 15 is close to the fuel pressure in the fuel return pipe 14 on the side to the fuel pressurizing chamber 27, and the pressure difference between them is smaller than the first pressure. The pressure relief valve 30 is therefore closed.

During the period from T4 to T8 thereafter, the fuel pressure in the fuel return pipe 14 on the side to the fuel delivery pipe 15 becomes much higher than the fuel pressure in the fuel return pipe 14 on the side to the fuel pressurizing chamber 27. The difference of the fuel pressure between the fuel pressure at the pump outlet and the fuel pressure in the fuel pressurizing chamber becomes larger than the first pressure at T5. Therefore, the pressure relief valve 30 starts to open at T5. A lift amount of the pressure relief valve 30 is increased from T5, as indicated by a solid line H. At T6, when the pressure relief valve 30 (more exactly, the first valve body 31 thereof) is brought into contact with the stopper 33, the lift amount of the pressure relief valve 30 becomes maximum. When the pressure relief valve 30 is closed thereafter, the lift amount of the pressure relief valve 30 becomes smaller.

A valve speed of the pressure relief valve 30 is gradually increased during the period from T5 to T6, as indicated by a solid line I. At T6, the pressure relief valve 30 (the first valve body 31) is brought into contact with (crashes into) the stopper 33, and thereby the valve speed of the pressure relief valve 30 is rapidly decreased. The pressure relief valve 30 rebounds after T6 and the crash between the pressure relief valve 30 and the stopper 33 is repeated by several times. Therefore, the valve speed of the pressure relief valve 30 is vibrated. When the pressure relief valve 30 is closed, the valve speed is designated by a negative figure.

A valve acceleration of the pressure relief valve 30 is increased during the period from T5 to T6, as indicated by a solid line J. At T6, the valve acceleration becomes zero. Since the crash between the pressure relief valve 30 and the stopper 33 is repeated by several times, the valve acceleration of the pressure relief valve 30 is likewise vibrated. When the pressure relief valve 30 is closed, the valve acceleration of the pressure relief valve 30 becomes a large figure.

As already explained, the inside fuel passage 41, in which the pressure holding valve 40 is provided, is formed in the inside of the first valve body 31 of the pressure relief valve 30. During the period from T3 to T4, the fuel pressure in the inside fuel passage 41 on the side to the fuel delivery pipe 15 is close to the fuel pressure in the inside fuel passage 41 on the side to the fuel pressurizing chamber 27, and the pressure difference between them is smaller than the second pressure. The pressure holding valve 40 is therefore closed during the period from T3 to T4.

During the period from T4 to T8 thereafter, the fuel pressure in the inside fuel passage 41 on the side to the fuel delivery pipe 15 becomes much higher than the fuel pressure in the inside fuel passage 41 on the side to the fuel pressurizing chamber 27. Since the difference of the fuel pressure between the fuel pressure at the pump outlet and the fuel pressure in the fuel pressurizing chamber 27 becomes larger than the second pressure, the pressure holding valve 40 is opened. As a result, as indicated by a solid line K, a lift amount of the pressure holding valve 40 (more exactly, the second valve body 43) is increased after T4 to such a lift amount, which is obtained in a normal operation.

During the period from T5 to T6, the pressure holding valve 40 is moved together with the first valve body 31 of the pressure relief valve 30 in a direction toward the fuel pressurizing chamber 27 (in the left-hand direction in FIG. 2). When the pressure relief valve 30 (the first valve body 31) crashes into the stopper 33 at T6, the second valve body 43 is further moved in the direction toward the fuel pressurizing chamber 27 due to inertia depending on a mass of the second valve body 43. As a result, the lift amount of the pressure holding valve 40 is rapidly increased after T6 and becomes to a maximum value at T7. Thereafter, the pressure relief valve 30 is closed and the lift amount of the pressure holding valve 40 is decreased to the lift amount, which is obtained in the normal operation.

After T8, that is, during the subsequent compression stroke, the pressure holding valve 40 is closed. Namely, the lift amount of the pressure holding valve 40 is decreased.

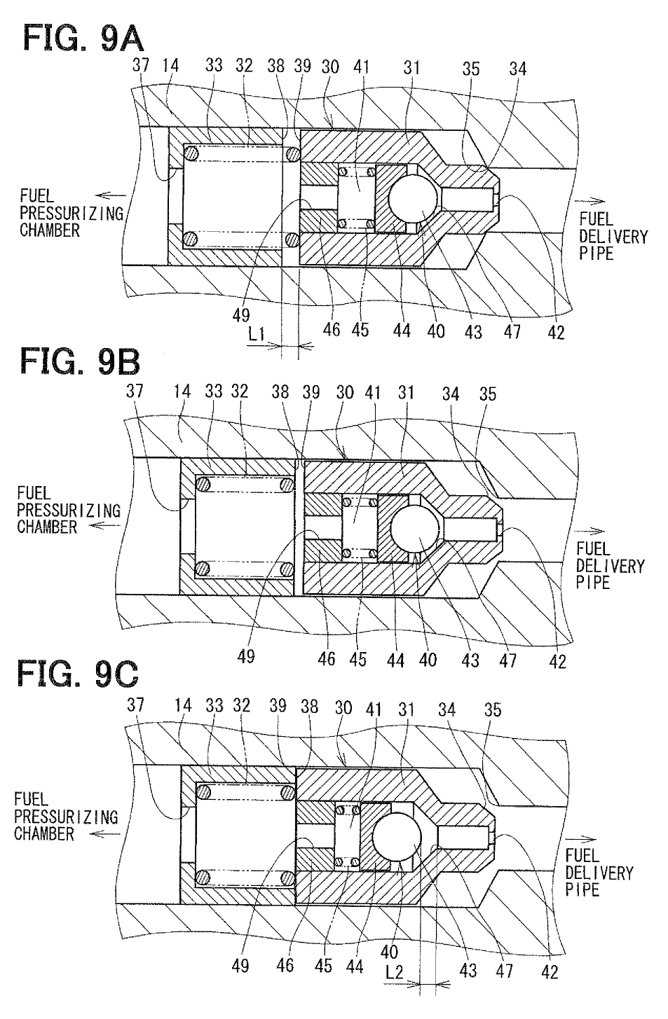

The operation of the pressure relief valve 30 and the pressure holding valve 40 will be further explained with reference to FIGS. 8 and 9A to 9C.

During the period from T3 to T4, the pressure relief valve 30 and the pressure holding valve 40 are closed, as explained above.

During the period from T4 to T5, as shown in FIG. 9A, the pressure holding valve 40 is opened, wherein the lift amount of the pressure holding valve 40 corresponds to the lift amount, which is obtained in the normal operation.

After the period after T5, as shown in FIG. 9B, when the first valve body 31 of the pressure relief valve 30 is moved in the direction to the fuel pressurizing chamber 27, the pressure holding valve 40 is also moved in the direction to the fuel pressurizing chamber 27 together with the first valve body 31. During this operation, the second valve body 43 of the pressure holding valve 40 is separated from and/or seated on the second valve seat 47. The valve acceleration of the second valve body 43 is increased by the first valve body 31.

At T6, when the end surface portion 39 of the first valve body 31 crashes into the end surface portion 38 of the stopper 33, the valve acceleration of the first valve body 31 is decreased on one hand. On the other hand, while the acceleration of the second valve body 43 is not decreased, the second valve body 43 is further moved in the direction (the left-hand direction) toward the fuel pressurizing chamber 27 due to the inertia depending on the mass of the second valve body 43.

Then, at T7, as shown in FIG. 9C, the lift amount of the second valve body 43 becomes at its maximum amount “L2”. In this situation, the extraneous material, which might have been attached to (or accumulated at) the space between the second valve body 43 and the second valve seat 47, can be removed from such space by the fuel flow through the space between the second valve body 43 and the second valve seat 47. In addition, the extraneous material attached to the second valve body 43 and/or the second valve seat 47 can be broken away from the second valve body 43 and/or the second valve seat 47 by the vibration generated at the crash between the first valve body 31 and the stopper 33.

According to the above embodiment, the controller 19 monitors the output of the fuel pressure sensor 18 after the engine operation is stopped. In the case that the fuel pressure in the delivery pipe 15 becomes lower than the second pressure, the controller 19 controls the power supply to the electromagnetic actuator 21 of the high pressure pump 20 when re-starting the engine operation, so that the fuel pressure in the fuel delivery pipe 15 is increased above the first pressure. As a result, the pressure relief valve 30 is opened, and the lift amount of the pressure holding valve 40 (which is provided in the inside of the pressure relief valve 30) is made larger than the lift amount which is obtained in the normal operation, by the inertia depending on the mass of the second valve body 43. Accordingly, the extraneous material (which might have been attached to or accumulated at the space between the second valve body 43 and the second valve seat 47) can be removed from the space between the second valve body 43 and the second valve seat 47.

As above, when the characteristic feature of the pressure holding valve 40 is changed or the performance thereof is deteriorated, the performance of the pressure holding valve 40 for holding the pressure can be restored to its normal operating condition by operating the pressure relief valve 30. Therefore, it is possible to suppress the generation of vapors in the fuel of the fuel supply system after the engine operation is stopped. In addition, it is possible to suppress the abnormal decrease of the fuel pressure in the fuel delivery pipe 15 when the acceleration pedal is released from the pedal pressing operation. As a result, the pressure holding valve 40 can maintain its performance even in the case that the extraneous material is attached thereto, and thereby the fuel supply system increases fuel consumption ratio and performance for starting the engine.

Furthermore, the controller 19 increases the fuel pressure in the fuel delivery pipe 15 above the first pressure at re-starting the engine operation. It is thereby possible to suppress deterioration for calmness and drivability by mixing operating sounds of the pressure relief valve 30 with operating sounds of the engine.

### Second Embodiment

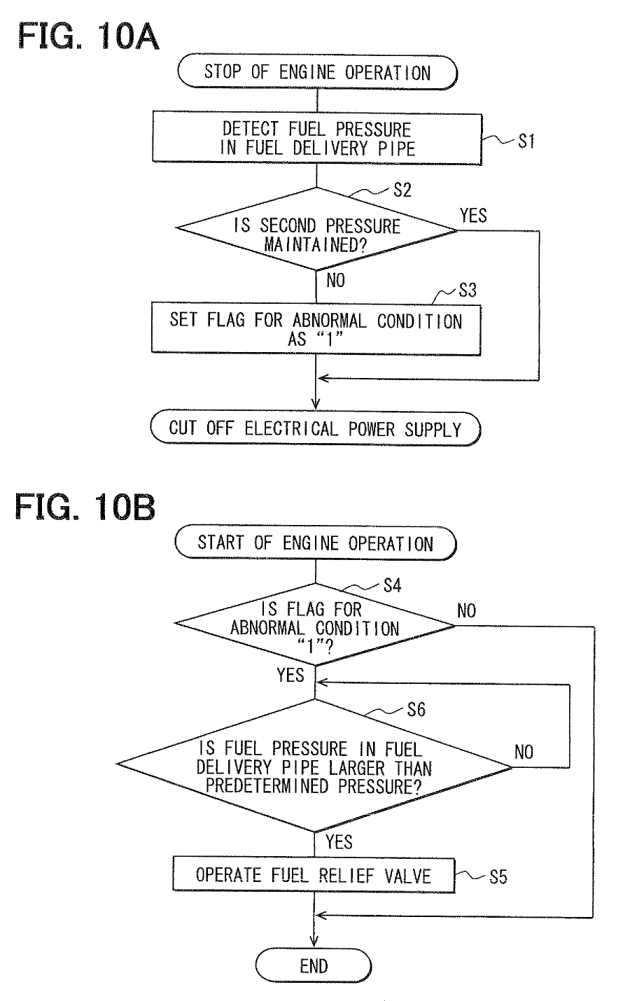

A fuel supply system, to which a pressure control valve according to a second embodiment of the invention is applied, will be explained with reference to FIGS. 10A and 10B.

According to the second embodiment, when the controller 19 determines at the step 54 (FIG. 10B) that the flag for the abnormal condition stored in the memory is “1”, YES at the step S4, the process is continued until the fuel pressure in the fuel delivery pipe 15 becomes higher than a predetermined value (NO at the step S6, FIG. 10B), and then the process is changed to the cleaning mode operation when the fuel pressure in the fuel delivery pipe 15 becomes higher than the predetermined value (YES at the step S6, FIG. 105).

The predetermined value means here pressure, which is close to but lower than the first pressure. Furthermore, the predetermined value means pressure in the fuel delivery pipe 15, which is close to maximum fuel injection pressure for the injections 17 during the vehicle accelerating period. In the cleaning mode operation, the controller 19 controls the power supply to the electromagnetic actuator 21 of the high pressure pump 20, so that the high pressure pump 20 pumps out all of the sucked fuel (that is, full pumping condition). In this case, the fuel discharge amount of the high pressure pump 20 is larger than the fuel amount injected through the injectors 17 during the vehicle accelerating period. Therefore, the fuel pressure in the fuel delivery pipe 15 is increased above the first pressure.

According to the present embodiment, when the fuel pressure in the fuel delivery pipe 15 is increased to become closer to the maximum fuel injection pressure of the injectors 17 during the vehicle accelerating period, the controller 19 controls the power supply to the high pressure pump 20 in order to operate the pressure relief valve 30. In this case, although the rotational speed of the engine is increased, it is possible to suppress deterioration for calmness and drivability by mixing the operating sounds of the pressure relief valve 30 with the operating sounds of the engine.

### Third Embodiment

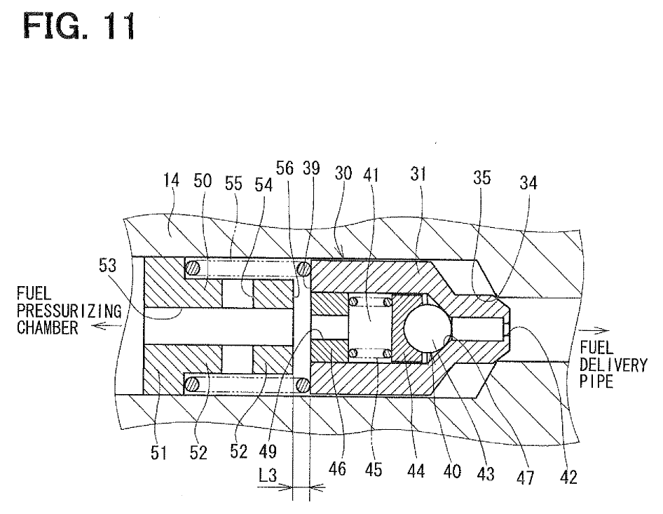

A pressure control valve according to a third embodiment of the invention will be explained with reference to FIG. 11. Shapes of a stopper 50 and a first spring 55 of the pressure relief valve 30 according to the third embodiment are different from those of the first embodiment.

The stopper 50 is formed in a cylindrical shape having a large diameter portion 51 and a small diameter portion 52. An outer peripheral wall of the large diameter portion 51 is fixed to the inner peripheral wall of the fuel return pipe 14. The small diameter portion 52 extends from one end of the large diameter portion 51 in the direction to the fuel delivery pipe 15.

A first through-hole 53 is formed in the stopper 50, which extends in its axial direction so that both axial end spaces thereof are communicated with each other. A second through-hole 54 is formed in the small diameter portion 52, wherein the second through-hole 54 extends in a radial direction. The first and second through-holes 53 and 54 are communicated with each other, so that fuel may flow through the through-holes.

The first spring 55 is provided between an outer peripheral wall of the small diameter portion 52 and the inner peripheral wall of the fuel return pipe 14. One end of the first spring 55 is locked to the end surface portion 39 of the first valve body 31, which is formed at the end of the first valve body on the side to the fuel pressurizing chamber. The other end of the first spring 55 is locked to an outer end of the large diameter portion 51 on the side to the fuel delivery pipe 15. The first spring 55 biases the first valve body 31 toward the first valve seat 35.

A movable space L3 is formed between an end surface portion 56 of the stopper 50 (on the side to the fuel delivery pipe 15) and the end surface portion 39 of the first valve body 31 (on the side to the fuel pressurizing chamber). The first valve body 31 is movable within the range of the movable space L3. The movable space L3 corresponds to a maximum lift amount of the pressure relief valve 30, when it opens the fuel return pipe 14.

According to the present embodiment, the first spring 55 is provided at the outer peripheral wall of the stopper 50. The stopper 50 and the first valve body 31 are brought into contact in a radial inside space of the first spring 55.

Even according to the above structure, when the characteristic feature of the pressure holding valve 40 is changed or the performance thereof is deteriorated, the pressure relief valve 30 is opened so that the end surface portion 39 of the first valve body 31 crashes into the end surface portion 56 of the stopper 50. As a result, the valve lift amount of the second valve body 43 can be made larger than the valve lift amount, which is obtained in the normal operation.

In this situation, the extraneous material, which might have been attached to (or accumulated at) the space between the second valve body 43 and the second valve seat 47, can be removed from such space by the fuel flow through the space between the second valve body 43 and the second valve seat 47. The pressure holding valve 40 can thereby maintain its performance even in the case that the extraneous material is attached thereto.

### Fourth Embodiment

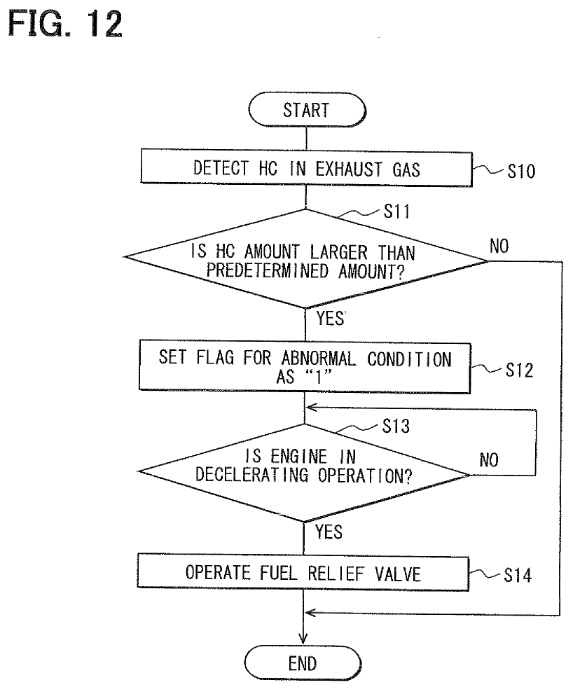

A process for the cleaning mode operation for the fuel supply system, to which the pressure control valve according to a fourth embodiment is applied, will be explained with reference to FIG. 12.

According to the present embodiment, an engine ECU (or the controller 19 in FIG. 1) detects at a step S10 unburned components of the fuel, such as hydrocarbons (HC), contained in exhaust gas. When the fuel pressure in the fuel delivery pipe 15 is decreased as a result that the performance of the pressure holding valve 40 for maintaining the fuel pressure is decreased, atomization of the fuel injected through the injectors 17 is deteriorated. Then, the amount of the unburned components of the fuel contained in the exhaust gas is increased. Therefore, when the amount of HC contained in the exhaust gas is increased, the extraneous material can be attached to or accumulated at the space between the second valve seat 47 and the second valve body 43 of the pressure holding valve 40.

When the detected HC amount is larger than a predetermined amount (YES at a step S11), the flag for the abnormal condition is set to “1” and this information is stored in the memory (at a step S12). When the detected HC amount is smaller than the predetermined amount (NO at the step S11), the process goes to end.

In the case that the flag for the abnormal condition stored in the memory is “1”, the controller 19 detects whether the engine is in a decelerating operation. In case of YES at a step S13, namely when the engine is in the decelerating operation, the controller 19 stops the fuel injection from the injectors 17 into the cylinders, while the controller 19 continuously drives the high pressure pump 20 so as to discharge the pressurized fuel. As a result, the fuel pressure in the fuel delivery pipe 15 is increased above the first pressure and the pressure relief valve 30 is moved in the valve opening direction to thereby carry out the cleaning mode operation.

As above, according to the present embodiment, the cleaning mode operation is carried out during the engine decelerating operation. Since fuel injection ports of the injectors 17 are closed during the engine decelerating operation, the fuel pressure in the fuel delivery pipe 15 can be rapidly increased.

When the cleaning mode operation has been carried out, the fuel pressure in the fuel delivery pipe 15 may be decreased due to the valve opening operation of the pressure relief valve 30, and thereby atomization of the fuel injected from the injectors 17 into the cylinders may not be sufficiently achieved. However, since the fuel injection from the injectors into the cylinders is stopped during the engine decelerating operation, it is possible to suppress deterioration of emission of the exhaust gas.

### Fifth Embodiment

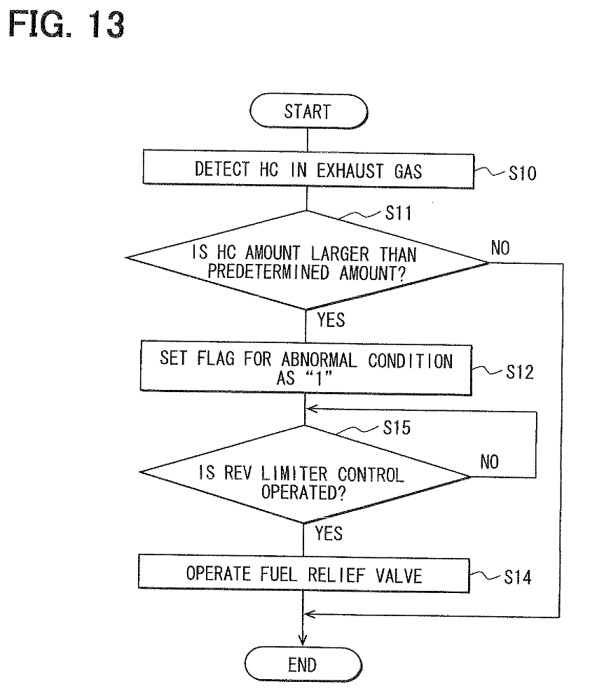

A process for the cleaning mode operation of the fuel supply system according to a fifth embodiment will be explained with reference to FIG. 13.

According to the present embodiment, when the flag for the abnormal condition stored in the memory is “1” (S12 in FIG. 13), the controller 19 detects at a step S15 whether a rev limiter control is operated or not as a result the engine speed is increased. In case of YES at the step S15, namely when the rev limiter control is operated, the controller 19 stops the fuel injection from the injectors 17 into the cylinders, while the controller 19 continuously drives the high pressure pump 20 so as to discharge the pressurized fuel. As a result, the fuel pressure in the fuel delivery pipe 15 is increased above the first pressure and the pressure relief valve 30 is moved in the valve opening direction.

Since fuel injection ports of the injectors 17 are closed during the operation for the rev limiter control, the fuel pressure in the fuel delivery pipe 15 can be rapidly increased. In addition, since the fuel injection from the injectors into the cylinders is stopped during the operation for the rev limiter control, it is possible to suppress deterioration of emission of the exhaust gas. Furthermore, since the engine speed is high during the operation for the rev limiter control, it is possible to suppress deterioration for calmness and drivability by mixing operating sounds of the pressure relief valve 30 with operating sounds of the engine.

### Sixth Embodiment

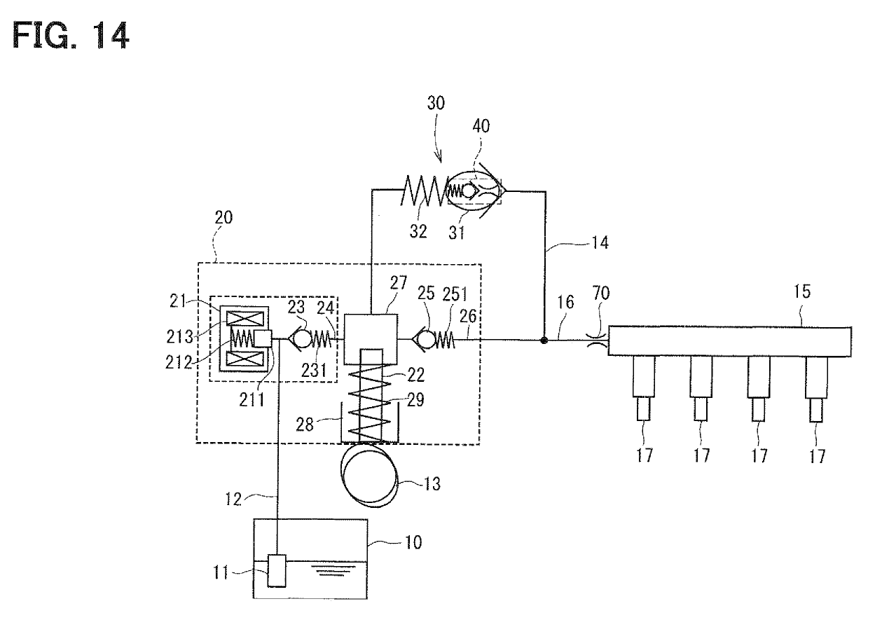

FIG. 14 schematically shows a fuel supply system, to which a pressure control valve according to a sixth embodiment of the invention is applied. According to the present embodiment, an orifice 70 is provided in the high pressure fuel pipe 16 for the fuel delivery pipe 15. The orifice 70 decreases pulsation of the fuel pressure in the fuel delivery pipe 15, which may be caused by on-off operations of the fuel injection ports of the injectors 17. In addition, the orifice 70 reflects pressure waves generated in the high pressure fuel pipe 16 by on-off operation of the discharge valve 25 of the high pressure pump 20. When the rotational speed of the engine reaches at a predetermined speed, the pressure waves generated by the on-off operation of the discharge valve 25 driven by the rotation of the cam shaft 13 may vibrate sympathetically with the pressure waves reflected by the orifice 70.

According to the present embodiment, specifications for the orifice 70, the fuel delivery pipe 15 and the high pressure fuel pipe 16 (such as, an inner diameter of the orifice 70; a length, a capacity, an elastic coefficient of material, and a wall thickness of the fuel delivery pipe 15; a length, an inner diameter, an elastic coefficient of material, and a wall thickness of the high pressure fuel pipe 16; and so on) are so designed that a maximum value of the fuel pressure caused by the resonance is higher than the first pressure.

As a result, it is possible to open the pressure relief valve 30 without specific operation for forcibly opening the pressure relief valve 30, such as those explained in the above first to fifth embodiments. Therefore, the first valve body 31 of the pressure relief valve 30 crashes into the stopper 33, and the lift amount of the second valve body 43 of the pressure holding valve 40 is made larger than the lift amount, which is obtained in the normal operation, by the inertia depending on the mass of the second valve body 43. As above, it is possible to suppress the deterioration for the performance of the pressure holding valve 40 for maintaining the fuel pressure.

### Seventh Embodiment

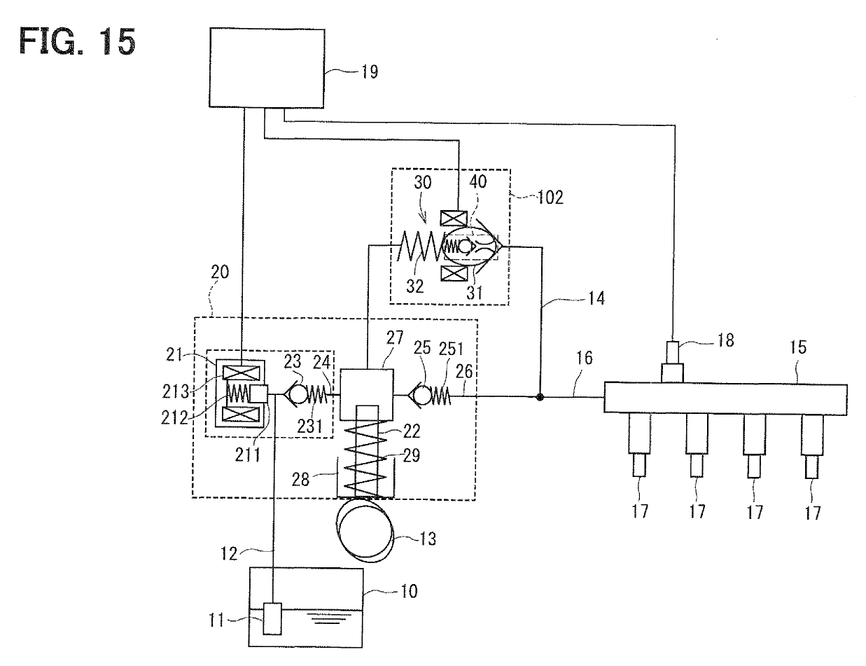

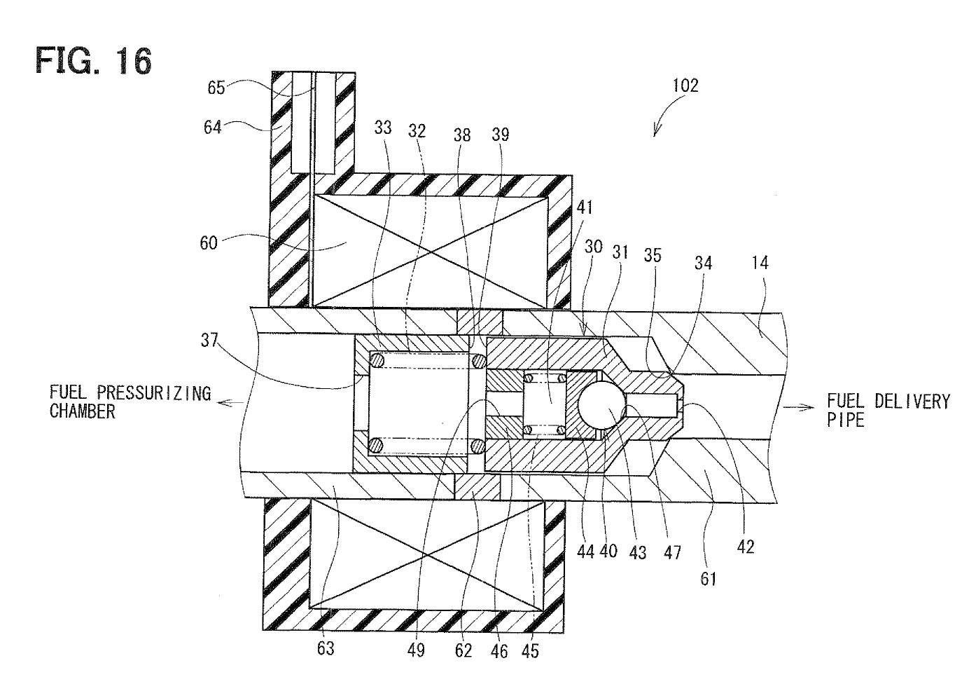

FIGS. 15 and 16 schematically show a fuel supply system, to which a pressure control valve according to a seventh embodiment of the invention is applied.

According to a pressure control valve 102 of the present embodiment, an electromagnetic coil 60 is provided at an outer periphery of the fuel return pipe 14. The fuel return pipe 14 has a first cylindrical portion 61 made of magnetic material, a second cylindrical portion 62 made of non-magnetic material and a third cylindrical portion 63 made of magnetic material, wherein those first to third portions are arranged in this order. The second cylindrical portion 62 is arranged at a position, which corresponds to an outer surface portion of the space formed between the first valve body 31 of the pressure relief valve 30 and the stopper 33. The first valve body 31 of the pressure relief valve 30 and the stopper 33 are made of magnetic material.

When electrical power is supplied from the controller 19 to the coil 60 via terminals 65 of a connector 64, electromagnetic field is generated at the coil 60, so that magnetic flux flows through a magnetic circuit which is formed by the first cylindrical portion 61, the first valve body 31, the stopper 33 and the third cylindrical portion 63. Electromagnetic force is thereby generated between the first cylindrical portion 61 and the stopper 33, so that the first valve body 31 is attracted toward the stopper 33.

According to the present embodiment, it is possible to move the first valve body 31 in the valve opening direction by supplying the electrical power to the coil 60. Namely, it is not necessary to control on-off operation of the fuel injection ports of the injectors 17, nor necessary to control discharging fuel amount of the high pressure pump 20. As a result, it is possible to carry out the cleaning mode operation at any desirable timing during the engine stopped period or any other engine operational period in which the deterioration of the emission and the drivability may not occur.

### Eighth Embodiment

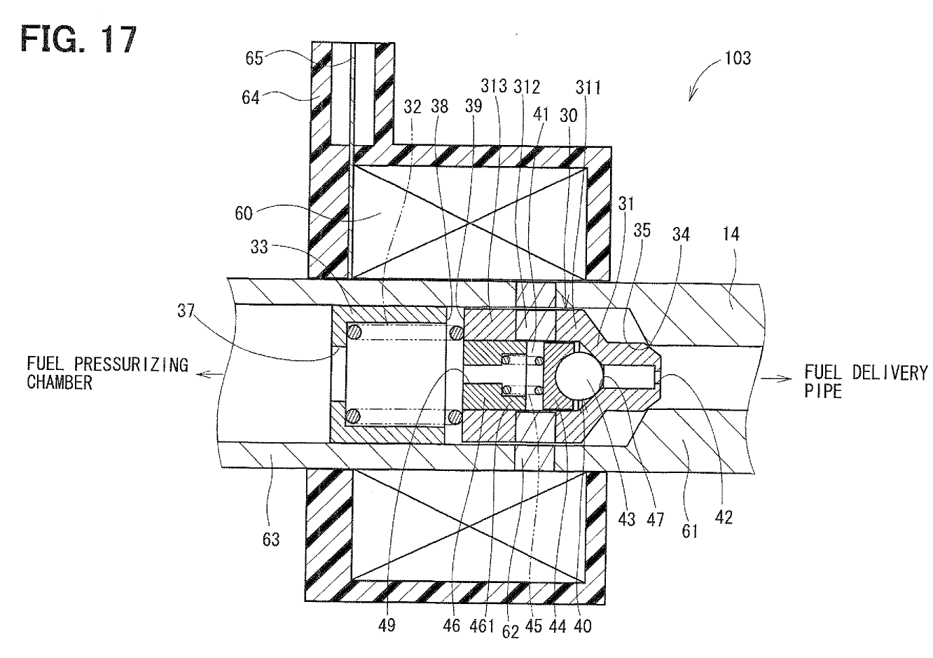

FIG. 17 schematically shows a part of a fuel supply system, to which a pressure control valve according to an eight embodiment of the invention is applied.

According to the present embodiment, the pressure holding valve 40 has a flux drawing portion 461 extending from the stopping member 46 toward the sliding member 44. The second valve body 43, the sliding member 44, the flux drawing portion 461 and the stopping member 46 are made of magnetic material.

The first valve body 31 of the pressure relief valve 30 is composed of a first valve portion 311 made of magnetic material, a second valve portion 312 made of non-magnetic material, and a third valve portion 313 made of magnetic material, wherein those first to third valve portions are arranged in this order. The second valve portion 312 is arranged at a position, which corresponds to an outer surface portion of the space formed between the flux drawing portion 461 and the sliding member 44 of the pressure relief valve 30.

The second cylindrical portion 62 of the fuel return pipe 14 is arranged at a position, which corresponds to an outer surface portion of the second valve portion 312.

When the electrical power is supplied from the controller 19 to the coil 60 via the terminals 65 of the connector 64, the electromagnetic field is generated at the coil 60, so that magnetic flux flows through a magnetic circuit which is formed by the first cylindrical portion 61, the first valve portion 311, the second valve body 43, the sliding member 44, the flux drawing portion 461 and the stopping member 46, the third valve portion 313, and the third cylindrical portion 63. Electromagnetic force is thereby generated between the flux drawing portion 461 and the sliding member 44, so that the sliding member 44 and the second valve body 43 are attracted toward the flux drawing portion 461.

According to the present embodiment, it is possible to move the second valve body 43 of the pressure holding valve 40 in the valve opening direction by supplying the electrical power to the coil 60. Accordingly, it is possible to carry out the cleaning mode operation at any desirable timing during the engine stopped period or any other engine operational period. As a result, it is possible to wipe out the fear for the possible deterioration of the emission and the drivability.

### Ninth Embodiment

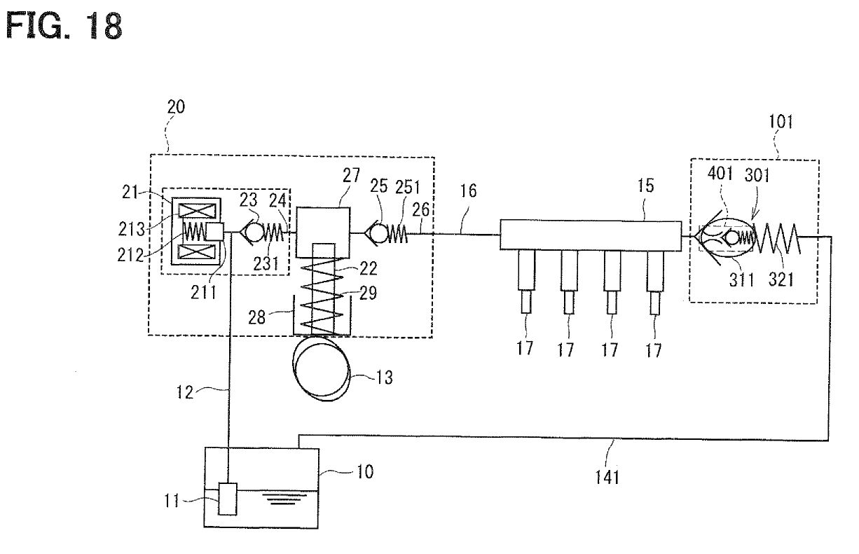

FIG. 18 schematically shows a fuel supply system, to which a pressure control valve according to a ninth embodiment of the invention is applied.

According to the present embodiment, a fuel return pipe 141 is provided between the fuel delivery pipe 15 and the fuel tank 10. A pressure control valve 101 is provided in the fuel return pipe 141. Even with such a structure for the ninth embodiment, the same or similar effects to those of the above first to eighth embodiments can be obtained.

### Tenth Embodiment

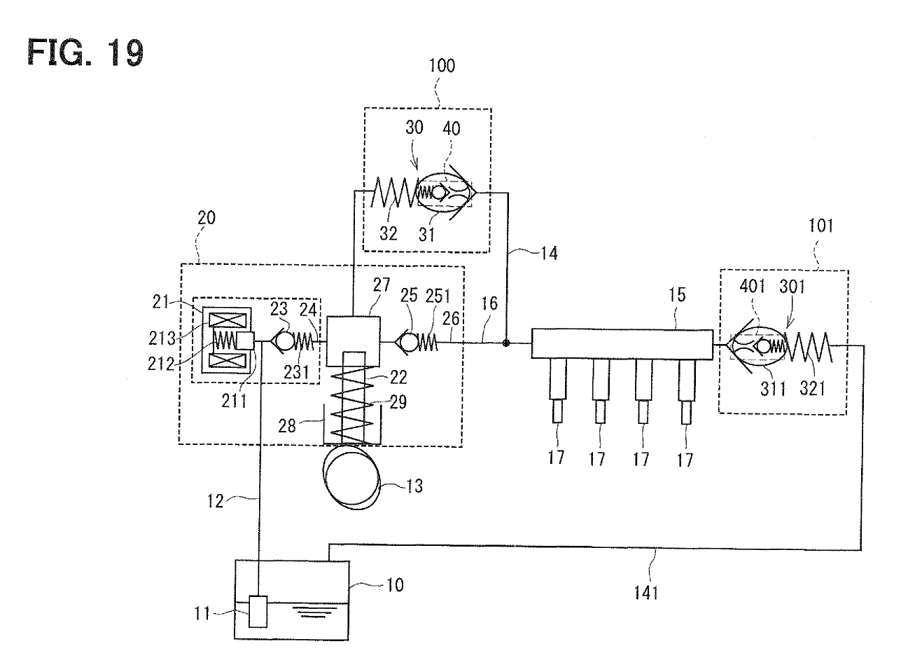

FIG. 19 schematically shows a fuel supply system, to which a pressure control valve according to a tenth embodiment of the invention is applied.

According to the present embodiment, the first fuel return pipe 14 is provided between the high pressure fuel pipe 16 and the fuel pressurizing chamber 27 of the high pressure pump 20, as in the same manner to the first embodiment. A second fuel return pipe 141 is further provided between the fuel delivery pipe. 15 and the fuel tank 10.

The first pressure control valve 100, which is composed of the first pressure relief valve 30, the first stopper and the first pressure holding valve 40, is provided in the first fuel return pipe 14. A second pressure control valve 101, which is composed of a second pressure relief valve 301, a second stopper and a second pressure holding valve 401, is provided in the second fuel return pipe 141. Each of the first and second pressure control valves 100 and 101 substantially has the same structure to that of the pressure control valve explained for the first to the ninth embodiments.

According to the present embodiment, even if one of the first and second pressure control valves 100 and 101 ware broken, the other pressure control valve can control the fuel pressure in the fuel delivery pipe 15.

### Other Embodiments

According to the above embodiments, the pressure relief valve is operated when the engine is started, accelerated, or decelerated or when the rev limiter control is operated. However, the pressure relief valve may be moved at any other timing.

According to some of the above embodiments, the controller is kept in its operation for the predetermined period after the engine operation is stopped and malfunction (or any abnormal condition) of the pressure holding valve is detected. According to the invention, however, it may possible to detect malfunction (or any abnormal condition) of the pressure holding valve at any engine operating condition, for example, at an engine idling operation.

According to some of the above embodiments, the pressure control valve is explained as such a device to be applied to the engine. However, the pressure control valve may be applied to any other devices than the engine.

As above, the present invention should not be limited to the above embodiments, but may be modified in various ways without departing from the spirit of the invention.

What is claimed is:

1. A fuel supply system for an internal combustion engine comprising:
a high pressure pump having a fuel pressurizing chamber for pressurizing low pressure fuel from a fuel tank:
a fuel delivery pipe for storing high pressure fuel pressurized by the high pressure pump:
a fuel injection device for injecting the high pressure fuel stored in the fuel delivery pipe into a cylinder of the engine: and a pressure control valve for controlling fuel pressure in the fuel delivery pipe,
wherein the pressure control valve comprises;
a pressure relief valve provided in a fuel return pipe which is connected between a high-pressure side of a fuel line for the high pressure pump and a low-pressure side of the fuel line for the high pressure pump, the pressure relief valve having a first valve body movably accommodated in the fuel return pipe;
the first valve body being operatively separated from a first valve seat formed at an inner peripheral wall of the fuel return pipe, when fuel pressure at the high-pressure side of the fuel line becomes higher than a first pressure, in order to open the pressure relief valve so that fuel flows from the high-pressure side of the fuel line to the low-pressure side of the fuel line;
a stopper provided in the fuel return pipe for limiting a movement of the first valve body when the pressure relief valve is opened, wherein the first valve body is brought into contact with the stopper so that the movement of the first valve body is limited by the stopper; and
a pressure holding valve provided in an inside fuel passage formed in the first valve body and having a second valve body movably accommodated in the inside fuel passage,
the second valve body being operatively separated from a second valve seat formed at an inner peripheral wall of the inside fuel passage, when the fuel pressure at the high-pressure side of the fuel line becomes higher than a second pressure which is lower than the first pressure, in order to open the pressure holding valve so that fuel flows from the high-pressure side of the fuel line to the low-pressure side of the fuel line.

2. The fuel supply system according to the claim 1, further comprising:
a fuel pressure sensor for detecting fuel pressure at the high-pressure side of the fuel line or fuel pressure in the fuel delivery pipe; and
an electronic control unit for directly or indirectly operating the pressure relief valve so as to open the pressure relief valve when fuel pressure detected by the fuel pressure sensor is lower than the second pressure, so that the first valve body crashes into the stopper.

3. The fuel supply system according to the claim 2, wherein
the electronic control unit determines whether the fuel pressure detected by the fuel pressure sensor is lower than the second pressure, after engine operation is stopped.

4. The fuel supply system according to the claim 2, wherein
the electronic control unit operates the pressure relief valve when the engine is started, so that the first valve body is moved in a valve opening direction and thereby the first valve body crashes into the stopper.

5. The fuel supply system according to the claim 2, wherein
the electronic control unit operates the pressure relief valve during the engine operation, when the fuel pressure detected by the fuel pressure sensor reaches at a predetermined value which is close to the first pressure, so that the first valve body is moved in a valve opening direction and thereby the first valve body crashes into the stopper.

6. The fuel supply system according to the claim 2, wherein
the electronic control unit controls discharge amount of the fuel from the high pressure pump to thereby increase the fuel pressure in the fuel delivery pipe above the first pressure, so that the first valve body is moved in a valve opening direction.

7. The fuel supply system according to the claim 2, wherein
the electronic control unit stops fuel injection from the fuel injection device into the cylinder and at the same time controls the high pressure pump to continuously discharge the high pressure fuel, to thereby increase the fuel pressure in the fuel delivery pipe above the first pressure.

8. The fuel supply system according to the claim 1, further comprising:
an electromagnetic coil provided around the pressure relief valve for generating magnetic field upon receiving electrical power,
wherein the first valve body of the pressure relief valve is moved in a direction toward the stopper by the magnetic field generated at the electromagnetic coil.

9. The fuel supply system according to the claim 1, further comprising:
an electromagnetic coil provided around the pressure relief valve for generating magnetic field upon receiving electrical power, and
a flux drawing portion provided in the pressure holding valve,
wherein the second valve body of the pressure holding valve is moved in a direction away from the second valve seat by the magnetic field generated at the electromagnetic coil.

10. The fuel supply system according to the claim 1, further comprising:
an orifice provided in the fuel line connected between the high pressure pump and the fuel delivery pipe and at such a position between the fuel return pipe and the fuel delivery pipe, so that the orifice decreases pulsation of the fuel pressure in the fuel delivery pipe and also reflects pressure waves generated by fuel discharge from the high pressure pump,
wherein the fuel pressure in the fuel line is higher than the first pressure and the pressure waves generated by fuel discharge from the high pressure pump vibrates sympathetically with the pressure waves reflected by the orifice, when the pressure waves generated by the fuel discharge from the high pressure pump reaches at a predetermined frequency.

11. The fuel supply system according to the claim 1, wherein
the fuel return pipe comprises;
a first fuel return pipe, one end of which is connected to the high-pressure side of the fuel lien and the other end of which is connected to the fuel pressurizing chamber of the high pressure pump; and
a second fuel return pipe, one end of which is connected to the fuel delivery pipe and the other end of which is connected to the fuel tank, and
the pressure control valve comprises a first pressure control valve provided in the first fuel return pipe and a second pressure control valve provided in the second fuel return pipe.

12. The fuel supply system according to the claim 1, further comprising:
a fuel pressure sensor for detecting fuel pressure at the high-pressure side of the fuel line or fuel pressure in the fuel delivery pipe; and
an electronic control unit for directly or indirectly operating the pressure relief valve at re-starting the engine so as to open the pressure relief valve, in the case that the fuel pressure detected by the fuel pressure sensor is lower than the second pressure when engine operation is stopped in a previous engine operation,
wherein the first valve body crashes into the stopper when the pressure relief valve is operated.

13. The fuel supply system according to the claim 1, further comprising:
an electronic control unit for determining whether an amount of hydrocarbons (HC) contained in exhaust gas emitted from the engine exceeds a predetermined amount,
the electronic control unit directly or indirectly operates the pressure relief valve, when the detected amount of hydrocarbons (HC) is larger than the predetermined amount and when the engine is in a decelerating condition in which fuel injection from the fuel injection device into the cylinder is stopped, so that the first valve body is moved toward the stopper and crashes into the stopper.

14. The fuel supply system according to the claim 1, further comprising:
an electronic control unit for determining whether an amount of hydrocarbons (HC) contained in exhaust gas emitted from the engine exceeds a predetermined amount,
the electronic control unit directly or indirectly operates the pressure relief valve, when the detected amount of hydrocarbons (HC) is larger than the predetermined amount and when the engine is in a rev limiter operating condition in which fuel injection from the fuel injection device into the cylinder is stopped, so that the first valve body is moved toward the stopper and crashes into the stopper.
